(19) United States
(12) Patent Application Publication
(10) Pub. No.: US 2023/0026066 A1
(43) Pub. Date: Jan. 26, 2023

(54) ROTOR FOR AN ELECTRIC MACHINE HAVING A WIDENED FILLING OR VENTING OPENING

(71) Applicant: Valeo Siemens eAutomotive Germany GmbH, Erlangen (DE)

(72) Inventors: Christoph Wieczorek, Bad Neustadt a.d.Saale (DE); Sebastian Dieterich, Bad Neustadt a.d.Saale (DE); Markus Rubi, Bad Neustadt a.d.Saale (DE); Alexander Schlereth, Bad Neustadt a.d.Saale (DE); Kay Lemmert, Bad Neustadt a.d.Saale (DE); Stephan Hellmuth, Bad Neustadt a.d.Saale (DE); Robert Werner, Bad Neustadt a.d.Saale (DE); Robin Büsch, Bad Neustadt a.d.Saale (DE)

(73) Assignee: Valeo Siemens eAutomotive Germany GmbH, Erlangen (DE)

(21) Appl. No.: 17/814,974

(22) Filed: Jul. 26, 2022

(30) Foreign Application Priority Data
Jul. 26, 2021 (DE) 10 2021 208 024.3

(51) Int. Cl. H02K 1/32; H02K 1/28; H02K 9/02; H02K 15/03

(52) U.S. Cl. CPC H02K 1/32; H02K 1/28; H02K 9/02; H02K 15/03; H02K 2213/03

(57) ABSTRACT

A rotor for an electric machine includes a sheet metal package formed from stacked electrical sheets and having magnet pockets arranged therein, a plurality of magnets of which at least one is inserted into each of the magnet pockets, a plurality of clearances which are each delimited by the magnets inserted into one of the magnet pockets and by the sheet metal package, a filling opening which is arranged on an axial side of the sheet metal package and through which a first of the clearances is exposed, and a venting opening which is arranged on the axial side and through which a second of the clearances is exposed. The outer end of the filling opening and/or the outer end of the venting opening are widened. Also described are an electric machine having the rotor, a vehicle having the machine and a method for producing the rotor.

The invention relates to a rotor for an electric machine having a sheet metal package formed from stacked electrical sheets, magnet pockets arranged therein and a plurality of magnets (permanent magnets) of which at least one is inserted into each of the magnet pockets.

Electric machines having such a rotor are increasingly used in electrically driven vehicles and hybrid vehicles, predominantly as electric motors for driving a wheel or an axle of such a vehicle.

Such an electric motor is normally mechanically coupled to a gearbox for rotational speed adaptation. The electric motor is additionally generally electrically coupled to an inverter which, from DC voltage that is provided from a battery, generates AC voltage, for example multi-phase AC voltage, for the operation of the electric motor.

It is also possible to operate an electric machine having such a rotor as generator for recovering movement energy of a vehicle. For this purpose, the movement energy is first converted into electrical energy and then into chemical energy of a vehicle battery.

It must be ensured that the magnets arranged in the magnet pockets maintain their position, in particular at high rotational speeds. In this respect, it is customary to pot the magnets with a potting compound. For this purpose, the nozzle of a metering device is introduced into a filling opening of the sheet metal package, whereupon the potting compound flows through the nozzle and the filling opening into the sheet metal package. Here, the potting compound can displace air which is present in the sheet metal package and which flows out of the sheet metal package through a venting opening. After the potting compound has cured, the magnets are securely fastened in the sheet metal package.

However, it may occur during the filling operation that potting compound comes out of the filling opening or the venting opening and accumulates on the sheet metal package. This undesired effect particularly occurs when the potting compound is introduced into the sheet metal package under pressure, the nozzle does not sufficiently seal the filling opening or the potting compound is not metered exactly. The potting compound on the sheet metal package can lead to damage during operation of the electric machine, and therefore this potting compound has to be laboriously removed.

It is therefore the object of the invention to specify a rotor for an electric machine in which a situation is avoided where potting compound used for fixing magnets in a sheet metal package of the rotor accumulates on the sheet metal package.

To achieve the object, there is provision according to the invention that, in a rotor of the type stated at the outset, it comprises the following: a plurality of clearances which are each delimited by the magnets inserted into one of the magnet pockets and by the sheet metal package, a filling opening which is arranged on an axial side of the sheet metal package and through which a first of the clearances is exposed, and a venting opening which is arranged on the axial side and through which a second of the clearances is exposed. A particular feature of the rotor is that the outer end of the filling opening is widened, the outer end of the venting opening is widened or both ends are widened.

By virtue of the widening (that is to say the widened region) of the filling opening, the nozzle of a metering device can be introduced into the filling opening particularly well and positioned there in such a way that the nozzle optimally seals the filling opening. This avoids potting compound getting onto the sheet metal package and accumulating there.

Furthermore, potting compound which threatens to come out of the venting opening can first accumulate in the widening thereof before the potting compound gets onto the sheet metal package. There thus remains sufficient reaction time to pause the filling operation, thereby avoiding overfilling of the sheet metal package that could lead to the accumulation of potting compound on the sheet metal package.

In summary, the widening of the filling opening or of the venting opening allows the potting of the magnets of the sheet metal package with potting compound to be carried out or controlled particularly well.

The outer end of the filling opening or of the venting opening can be understood to mean that portion of the respective opening that is arranged on the surface of the sheet metal package. In addition to the filling opening and the venting opening, the rotor can have further such filling openings and/or venting openings through each of which one of the clearances is exposed.

The sheet metal package may have been formed from the electrical sheets by the latter having been welded, adhesively bonded, punch-stacked or fastened to one another in some other way. In particular, the sheet metal package can have a cylindrical shape. Furthermore, each electrical sheet can have a central opening, which openings, in the mounted state, form an axial bore of the sheet metal package through which a rotor shaft of the rotor can lead. The axis of the rotor shaft or of the rotor corresponds to the axial axis of the sheet metal package.

The magnets inserted into a magnet pocket are preferably axially lined up. Thus, during mounting of the rotor, the magnets can be simply inserted or pushed into the magnet pocket one after the other. The axially lined-up magnets are referred to as a “magnet stack”. The rotor can have a plurality of such magnet stacks which are each arranged in a magnet pocket. As an alternative to a magnet stack, a magnet pocket can also receive a single magnet.

A preferred development of the invention provides that a first end plate in which the filling opening and the venting opening are provided is arranged on the axial side of the rotor. In addition, the rotor comprises a second end plate arranged on the opposite axial side of the sheet metal package.

The two end plates can serve to axially compress the electrical sheets such that they do not detach from one another, even at high rotational speeds. The venting opening can be arranged on the axial side or a radial side of the first end plate.

It is further preferred that one of the widened ends (or one of the widenings) is in the form of a truncated cone with an outwardly increasing diameter. The widening thus forms a type of funnel. It is also possible that both the filling opening and the venting opening each widen outwardly in the form of a truncated cone. This truncated cone can be in particular a right truncated cone. As an alternative to the truncated cone shape, some other shape for the widening can also be used, for example a cylindrical shape or a hemispherical shape.

The opening angle of such a truncated cone or of a corresponding cone can be, for example, from 90° to 150°, from 110° to 130°, 120°, 90°, more than 90° or 19°. The opening angle is particularly preferably 60°. The opening angle can be understood to mean the double of an angle which is formed by a generatrix and the cone axis of the truncated cone.

Furthermore, the first clearance can be formed on a lateral surface of a magnet pocket, with the second clearance being formed on an opposite lateral surface of the magnet pocket. Consequently, the magnets arranged between the two clearances can be fastened particularly well by potting with the potting compound.

In one embodiment of the invention, the first clearance and the second clearance are connected to form a continuous channel. Therefore, potting compound filled into the first clearance can pass into the second clearance, whereby no separate filling of the second clearance is necessary. Moreover, when filling potting compound into the first clearance, air contained therein can escape outwardly through the connecting channel and the second clearance.

Furthermore, the sheet metal package can be composed of a plurality of sheet metal package segments, wherein one or more of the sheet metal package segments can be turned with respect to one or more of the other sheet metal package segments in the circumferential direction. In this way, the rotational behaviour of the rotor can be improved.

In the case of the rotor according to the invention, the magnets are preferably potted with a potting compound which is introduced into the clearances and which fills the clearances. Normally, the clearances are completely filled with potting compound. However, it is also possible to only partially fill the clearances with potting compound. The potting compound used can be, inter alia, an epoxy resin, a mixture of an epoxy resin and a curing agent, or an adhesive.

In addition, the invention relates to an electric machine having a rotor of the type described. In addition to the rotor, the electric machine can have a stator with respect to which the rotor can be rotated.

The stator can have a further sheet metal package (stator core) which has been formed from stacked electrical sheets. In addition, the stator can have windings of electrical conductors, for example as coil windings or flat wire windings. Furthermore, the machine can be equipped with a housing in which the rotor and the stator are received, wherein the rotor shaft can project from the housing.

Furthermore, the invention relates to a vehicle having such an electric machine which is provided for driving the vehicle. The machine can in particular drive a wheel or an axle of the vehicle.

In addition, the invention relates to a method for producing a rotor for an electric machine, comprising the following steps:
forming a sheet metal package, in which magnet pockets are arranged, from stacked electrical sheets,
inserting at least one of the magnets into each of the magnet pockets, with the result that a plurality of clearances are formed which are each delimited by the magnets inserted into one of the magnet pockets and by the sheet metal package,
arranging a first end plate having a filling opening, through which a first of the clearances is exposed, and a venting opening, through which a second of the clearances is exposed, on an axial side of the sheet metal package, wherein the outer end of the filling opening and/or the outer end of the venting opening are widened,
arranging a second end plate on the opposite axial side of the sheet metal package,
clamping the two end plates together using clamping elements, and
potting the magnets inserted into the magnet pockets with a potting compound which is introduced into the sheet metal package through the filling opening.

Furthermore, the invention relates to another method for producing a rotor for an electric machine, comprising the following steps:
forming a sheet metal package, in which magnet pockets are arranged, from stacked electrical sheets,
inserting at least one of the magnets into each of the magnet pockets, with the result that a plurality of clearances are formed which are each delimited by the magnets inserted into one of the magnet pockets and by the sheet metal package,
arranging a potting plate having a filling opening, through which a first of the clearances is exposed, and a venting opening, through which a second of the clearances is exposed, on an axial side of the sheet metal package, wherein the outer end of the filling opening and/or the outer end of the venting opening are widened,
potting the magnets inserted into the magnet pockets with a potting compound which is introduced into the sheet metal package through the filling opening, and
removing the potting plate from the sheet metal package.

In both methods according to the invention, a nozzle of a metering device can be inserted into the filling opening during the potting operation and the shape of which corresponds to the shape of the filling opening. As a result, the filling opening is optimally sealed.

The potting operation is preferably carried out under positive pressure, thereby reducing the time period required for introducing the potting compound.

In a variant of the methods according to the invention, the filling level of the potting compound in the venting opening is automatically monitored. When a specified filling level has been reached, the supply of the potting compound can be stopped.

The filling level can, for example, be monitored with a filling level sensor of the metering device. The filling level sensor allows the monitoring to be automated. A suitable filling level sensor is, inter alia, one which contactlessly detects the filling level, for example an optical filling level sensor or an ultrasound filling level sensor.

Exemplary embodiments of the invention will be explained below with reference to the figures. The figures are schematic illustrations in which:

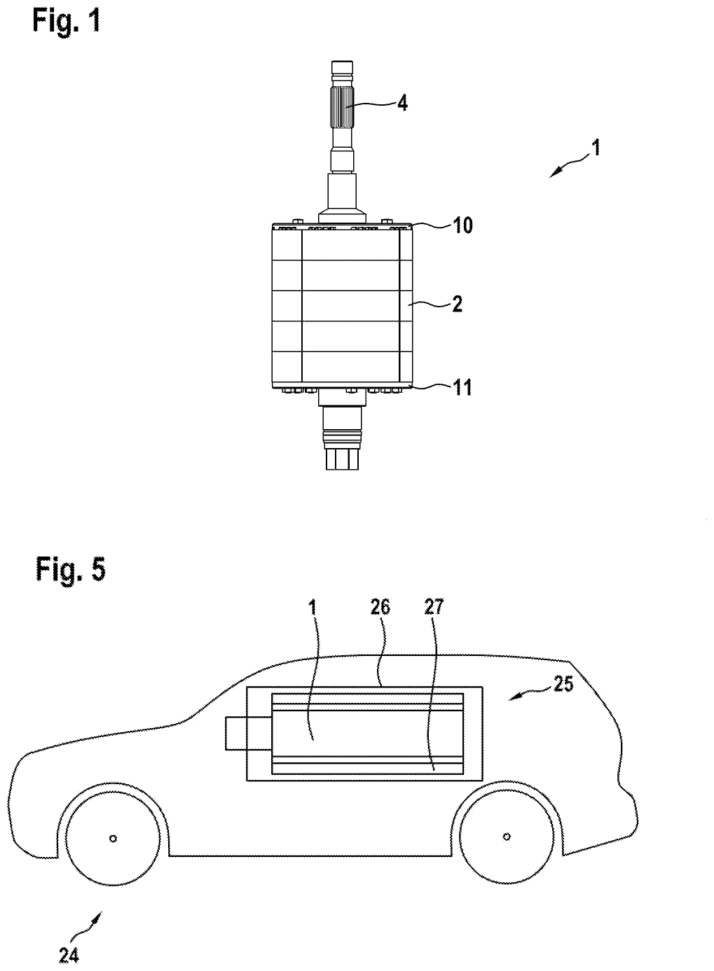

FIG. 1 shows a side view of a rotor according to a first embodiment of the invention,

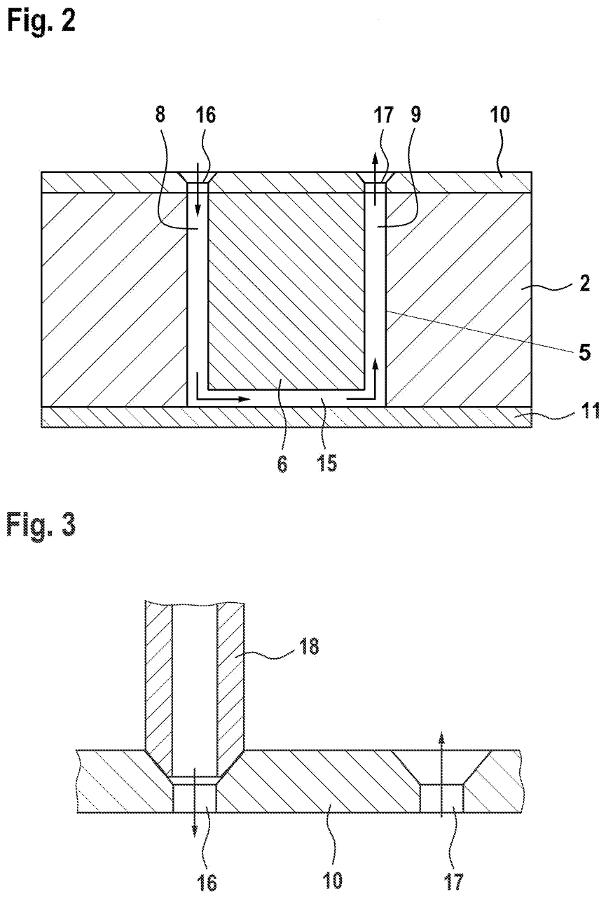

FIG. 2 shows a sectional view of a sheet metal package of the rotor,

FIG. 3 shows an enlarged sectional view of a detail of an end plate of the rotor,

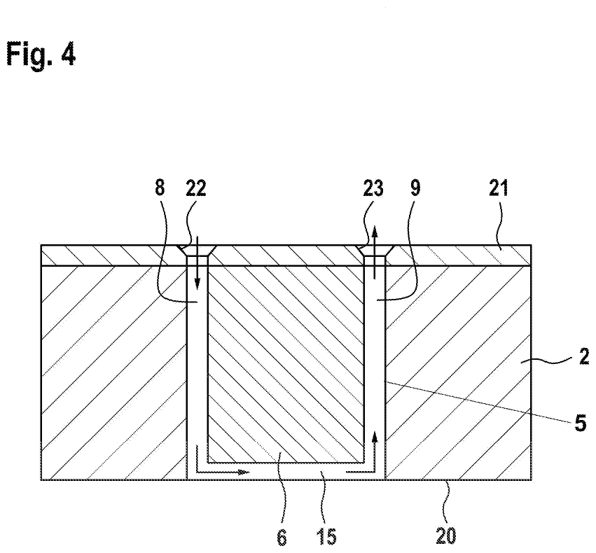

FIG. 4 shows a sectional view of a sheet metal package of a rotor according to a second embodiment of the invention,

FIG. 5 shows a vehicle having an electric machine having a rotor according to the invention.

FIG. 1 shows a rotor 1 according to a first embodiment of the invention in a side view. The rotor 1 belongs to an electric machine which is used for driving a vehicle.

The rotor 1 has a cylindrical sheet metal package 2 which encloses a rotor shaft 4 of the rotor 1. The sheet metal package 2 is composed of electrical sheets which are stacked in the axial direction and which are identically formed punched parts. The electrical sheets are divided over five sheet metal package segments, although it would also be possible to use a different number of sheet metal package segments or an unsegmented sheet metal package.

Along its circumference, a plurality of magnet pockets (not shown) are arranged in the sheet metal package 2 and each extend from an axial side of the sheet metal package 2 to its opposite axial side. In a magnet pocket there are axially lined up a plurality of cuboidal magnets which form a magnet stack. Thirty-two such magnet stacks are accommodated in the sheet metal package, although a different number of magnet stacks can also be used.

Situated next to each magnet stack are two clearances which are each delimited by the magnet stack and the sheet metal package 2. In other words, each magnet pocket has a first clearance formed on a lateral surface of the magnet pocket and a second clearance formed on an opposite lateral surface of the magnet pocket which are separated from one another by a magnet stack. The first clearance and the second clearance run parallel to one another from an axial side to the opposite axial side of the sheet metal package 2.

Furthermore, the rotor 1 has a first end plate 10 and a second end plate 11 which are arranged on opposite axial sides of the sheet metal package 2 and are connected to one another using clamping elements in the form of screws. As a result, a compressive force or prestressing force is permanently applied to the sheet metal package 2. This avoids the electrical sheets of the sheet metal package 2 detaching from one another, in particular at high rotational speeds of the rotor 1.

FIG. 2 shows a sectional view of the sheet metal package 2 with the first end plate 10 and the second end plate 11. Also illustrated by way of example is one of the magnet pockets 5 with a magnet stack 6 arranged therein. However, instead of the magnet stack 6, a single magnet can also be provided.

Also situated in the magnet pocket 5 are a first clearance 8 and a second clearance 9 which are each delimited by the magnet stack 6 and the sheet metal package 2. The first clearance 8 is formed on a lateral surface of the magnet pocket 5, and the second clearance 9 is formed on an opposite lateral surface of the magnet pocket 5.

The first clearance 8 is exposed through a filling opening 16 which axially traverses the first end plate 10. The second clearance 9 is exposed through a venting opening 17 which likewise axially traverses the first end plate 10. Alternatively, a venting opening could emerge radially from the first end plate.

The filling opening 16 and the venting opening 17 are each widened at their outer end. Each of the two widenings is in the form of a truncated cone having a diameter which increases towards the outer end of the respective opening.

Furthermore, the first clearance 8 and the second clearance 9 are connected to one another by a connecting channel 15 to form a continuous channel which runs from the filling opening 16 to the venting opening 17. The connecting channel 15 runs in particular between the magnet stack 6 and the second end plate 11. For this purpose, the magnet stack 6 can be supported on the second end plate 11 in a suitable manner.

FIG. 3 shows a sectional view of an enlarged detail of the first end plate 10 with the filling opening 16 and the venting opening 17. It can be seen there that the widening of the filling opening 16 and the widening of the venting opening 17 each extend over approximately half the thickness of the first end plate 10.

In a method according to the invention for producing the rotor 1, the following steps are carried out:

In a first method step, the sheet metal package 2, in which the magnet pockets 5 are arranged, is assembled from stacked electrical sheets.

In a second method step, a plurality of magnets are inserted into each magnet pocket 5. In particular, the magnets are axially lined up so as to form a magnet stack 6. Remaining next to each magnet stack 6 are two clearances 8, 9 which are each delimited by the magnet stack 6 and the sheet metal package 2.

In a third method step, the first end plate 10 is arranged on an axial side of the sheet metal package 2 such that the first clearance 8 is exposed through the filling opening 16 and the second clearance 9 is exposed through the venting opening 17.

In a fourth method step, the second end plate 11 is arranged on the opposite axial side of the sheet metal package 2.

In a fifth method step, the two end plates 10, 11 are clamped by means of the clamping elements. The rotor 1 completed in this way is oriented vertically, with the first end plate 10 to the top (cf. FIG. 1).

In a sixth method step, the magnets are potted with a potting compound such that the clearances 8, 9 are filled with the potting compound.

For this purpose, a nozzle 18 of a metering device is inserted into the filling opening 16 of the first end plate 10 (cf. FIG. 3). In particular, the nozzle 18 is placed on the inner wall of the widening of the filling opening 16 that is in the form of a truncated cone.

The shape of the nozzle 18 corresponds to the shape of the filling opening 16 in that the front end of the nozzle 18 is likewise in the form of a truncated cone. Furthermore, the opening angle of the truncated cone of the nozzle corresponds to the opening angle of the truncated cone of the filling opening 16. As a result, the nozzle 18 optimally seals the filling opening 16.

Furthermore, the potting compound is pressed with positive pressure through the nozzle 18 into the first clearance 8 by means of the metering device such that the potting compound flows through the first clearance 8 and the connecting channel 15 into the second clearance 9.

Specifically, the potting compound first of all flows axially downwards through the first clearance 8 as far as the second end plate 11. The potting compound then flows horizontally through the connecting channel 15 to the second clearance 9. The potting compound then rises axially upwards through the second clearance 9 as far as the first end plate 10. Here, air which is present in the magnet pocket 5 can escape through the venting opening 17 and be replaced by the potting compound. The flow direction of the potting compound or air is in each case symbolized by arrows in FIGS. 2 and 3.

If the potting compound that has risen in the second clearance 9 reaches as far as the widening of the venting opening 17 that is in the form of a truncated cone, the filling level of the potting compound increases further particularly slowly. As a result, there remains sufficient reaction time to break off the filling operation so as to avoid overfilling the channel with potting compound. In addition, the filling level in the widening can be monitored particularly well, for example by means of an optical filling level sensor.

The widening of the venting opening 17 also serves as a reservoir for the potting compound. If air bubbles rise in the second clearance 9 after filling with the potting compound, the additional potting compound present in the widening of the venting opening 17 can replace the volume lost by the air bubbles that have risen.

The potting compound is cured after the potting operation. In addition, the rotor shaft 4 can be guided through an axially extending central through-opening in the sheet metal package 2 (and corresponding openings in the end plates 10, 11) such that the sheet metal package 2 encloses the rotor shaft 4 or is fastened thereto.

FIG. 4 shows a sectional view of a sheet metal package 2 of a rotor according to a second embodiment of the invention. The rotor corresponds to the rotor 1 shown in FIG. 1, but, unlike the latter, has no end plates and clamping elements.

Illustrated, inter alia, is one of the magnet pockets 5 of the rotor having a magnet stack 6 arranged therein. In addition, a first clearance 8 and a second clearance 9 are arranged in the magnet pocket 5 and are each delimited by the magnet stack 6 and the sheet metal package 2. The first clearance 8 is formed on a lateral surface of the magnet pocket 5, and the second clearance 9 is formed on an opposite lateral surface of the magnet pocket 5.

Also illustrated is a potting plate 21 placed on the sheet metal package 2. The first clearance 8 is exposed through a filling opening 22 which axially traverses the potting plate 21. The second clearance 9 is exposed through a venting opening 23 which likewise axially traverses the potting plate 21.

The filling opening 22 and the venting opening 23 are each widened at their outer end. Each of the widenings is in the form of a truncated cone having a diameter which increases towards the outer end of the respective opening.

Furthermore, the first clearance 8 and the second clearance 9 are connected to one another by a connecting channel 15 to form a continuous channel. The channel runs from the filling opening 22 to the venting opening 23. In particular, the connecting channel 15 runs between the magnet stack 6 and an end lamination of the sheet metal package 2. For this purpose, the connecting channel 15 can be realized by means of a suitable curvature of the end lamination 20.

In a method according to the invention for producing the rotor, the following steps are carried out:

In a first method step, the sheet metal package 2, in which the magnet pockets 5 are arranged, is assembled from stacked electrical sheets.

In a second method step, a plurality of magnets are inserted into each magnet pocket 5. In particular, the magnets are axially lined up so as to form a magnet stack 6. Remaining next to each magnet stack 6 are two clearances 8, 9 which are each delimited by the magnet stack 6 and the sheet metal package 2. The rotor completed in this way is oriented vertically, with an axial side to the top.

In a third method step, the potting plate is placed on the sheet metal package 2 such that the first clearance 8 is exposed through the filling opening 22 and the second clearance 9 is exposed through the venting opening 23.

In a fourth method step, the magnets are potted with a potting compound such that the clearances 8, 9 are filled with the potting compound. Here, the procedure is operated as for the rotor 1 according to the first embodiment of the invention.

In a fifth method step, the potting plate is removed from the sheet metal package 2.

The potting compound is cured after the potting operation. In addition, the rotor shaft 4 can be guided through an axially extending central through-opening in the sheet metal package 2 such that the sheet metal package 2 encloses the rotor shaft 4 or is fastened thereto.

FIG. 5 shows a vehicle 24 having an electric machine 25 which serves for driving the vehicle 24. The machine 25 has a housing 26 in which are received the rotor 1 according to the invention and a stator 27 which surrounds the rotor 1.

### LIST OF REFERENCE SIGNS

1 Rotor
2 Sheet metal package
4 Rotor shaft
5 Magnet pocket
6 Magnet stack
8 Clearance
9 Clearance
10 End plate
11 End plate
15 Connecting channel
16 Filling opening
17 Venting opening
18 Nozzle
20 End lamination
21 Potting plate
22 Filling opening
23 Venting opening
24 Vehicle
25 Electric machine
26 Housing
27 Stator

1. A rotor for an electric machine, comprising:
a sheet metal package formed from stacked electrical sheets and having magnet pockets arranged therein,
a plurality of magnets of which at least one is inserted into each of the magnet pockets,
a plurality of clearances which are each delimited by the magnets inserted into one of the magnet pockets and by the sheet metal package,
a filling opening which is arranged on an axial side of the sheet metal package and through which a first of the clearances is exposed, and a venting opening which is arranged on the axial side and through which a second of the clearances is exposed, wherein the outer end of the filling opening and/or the outer end of the venting opening are widened.

2. The rotor according to claim 1 having a first end plate which is arranged on the axial side and in which the filling opening and the venting opening are arranged, and a second end plate which is arranged on the opposite axial side of the sheet metal package.

3. The rotor according to claim 1, wherein one of the widened ends is in the form of a truncated cone with an outwardly increasing diameter.

4. The rotor according to claim 3, wherein the opening angle of the truncated cone is from 90° to 150°, from 110° to 130°, 120°, 90°, 19°, more than 90° or 60°.

5. The rotor according to claim 1, wherein the first clearance is connected to the second clearance to form a continuous channel.

6. The rotor according to claim 1, wherein the first clearance is arranged on a lateral surface of one of the magnet pockets, and the second clearance is arranged on an opposite lateral surface of the magnet pocket.

7. The rotor according to claim 1, wherein the sheet metal package has a plurality of axially lined-up sheet metal package segments, and one of the sheet metal package segments is rotated with respect to another of the sheet metal package segments in the circumferential direction.

8. The rotor according to claim 1, wherein the magnets are potted with a potting compound introduced into the clearances.

9. An electric machine having a rotor according to claim 1.

10. A vehicle having an electric machine according to claim 9 which is provided for driving the vehicle.

11. A method for producing a rotor for an electric machine, comprising:
forming a sheet metal package, in which magnet pockets are arranged, from stacked electrical sheets,
inserting at least one of the magnets into each of the magnet pockets, with the result that a plurality of clearances are formed which are each delimited by the magnets inserted into one of the magnet pockets and by the sheet metal package,
arranging a first end plate having a filling opening, through which a first of the clearances is exposed, and a venting opening, through which a second of the clearances is exposed, on an axial side of the sheet metal package
wherein the outer end of the filling opening and/or the outer end of the venting opening are widened,
arranging a second end plate on the opposite axial side of the sheet metal package,
clamping the two end plates together using clamping elements; and
potting the magnets inserted into the magnet pockets with a potting compound which is introduced into the sheet metal package through the filling opening.

12. A method for producing a rotor for an electric machine, comprising:
forming a sheet metal package, in which magnet pockets are arranged, from stacked electrical sheets,
inserting at least one of the magnets into each of the magnet pockets, with the result that a plurality of clearances are formed which are each delimited by the magnets inserted into one of the magnet pockets and by the sheet metal package,
arranging a potting plate having a filling opening, through which a first of the clearances is exposed, and a venting opening, through which a second of the clearances is exposed, on an axial side of the sheet metal package, wherein the outer end of the filling opening and/or the outer end of the venting opening are widened,
potting the magnets inserted into the magnet pockets with a potting compound which is introduced into the sheet metal package through the filling opening, and
removing the potting plate from the sheet metal package.

13. The method according to claim 11, wherein a nozzle of a metering device is inserted into the filling opening during the potting operation and the shape of which corresponds to the shape of the filling opening.

14. The method according to claim 11, wherein the potting operation is carried out under positive pressure.

15. The method according to claim 11, wherein the filling level of the potting compound in the venting opening is automatically monitored during the potting operation.
